(19) United States
(12) Patent Application Publication
(10) Pub. No.: US 2014/0271079 A1
(43) Pub. Date: Sep. 18, 2014

(54) HYDRAULIC GRAPPLE DAMPER

(71) Applicant: DEERE & COMPANY, Moline, IL (US)

(72) Inventors: Gary R. Fichtinger, Hazel Green, WI (US); Robert T. Carr, Rickardsville, IA (US); Timothy L. Jerew, DeWitt, IA (US); Monica C. Allen, Woodbine, MD (US)

(21) Appl. No.: 13/832,856

(22) Filed: Mar. 15, 2013

(51) Int. Cl. B66C 23/46

(52) U.S. Cl. CPC B66C 23/46
USPC 414/729; 414/815

(57) ABSTRACT

A work vehicle is disclosed having a chassis, a work tool rotatably coupled to the chassis, and one or more hydraulic dampers. The hydraulic damper includes a moveable body that resists rotation in a hydraulic chamber to resist rotation of the work tool relative to the chassis.

### FIELD

The present disclosure relates to a damper for a grapple skidder. More particularly, the present disclosure relates to a hydraulic damper for a grapple skidder, and to a method for using the same.

### BACKGROUND

Grapple skidders are forestry work vehicles used to haul logs. The skidder is typically provided with a boom assembly that can be manipulated into a variety of positions. A grapple is mounted to the end of the boom assembly via a swivel link. The swivel link is pivotally coupled to the boom assembly by a first pivot connection and to the grapple by a second pivot connection. The first pivot connection allows for fore-aft movement of the grapple relative to the boom assembly, and the second pivot connection allows for side-to-side movement of the grapple relative to the boom assembly.

One or both of the first and second pivot connections of the swivel link may include a damper for dampening any excessive oscillations in the swivel link caused by the swinging movement of the grapple. Specifically, the first pivot connection may include a first damper, and the second pivot connection may include a second damper. Known dampers include friction plates used as brakes, for example. However, known dampers may require initial break-in periods, may experience high operating temperatures, may require frequent maintenance, and may achieve limited operating lives.

### SUMMARY

The present disclosure provides a work vehicle having a chassis, a work tool rotatably coupled to the chassis, and one or more hydraulic dampers. The hydraulic damper includes a moveable body that resists rotation in a hydraulic chamber to resist rotation of the work tool relative to the chassis.

According to an embodiment of the present disclosure, a work vehicle is provided including a chassis, at least one traction device supporting the chassis on the ground, a work tool configured to rotate relative to the chassis about a first axis, and a first damper configured to resist movement of the work tool about the first axis. The first damper includes a housing that defines a chamber for receipt of hydraulic fluid, and a moveable body that rotates in the chamber, the hydraulic fluid resisting rotation of the moveable body in the chamber to resist movement of the work tool about the first axis.

According to another embodiment of the present disclosure, a work vehicle is provided including a chassis, at least one traction device supporting the chassis on the ground, a work tool configured to rotate relative to the chassis about a first axis, and a first damper configured to resist movement of the work tool about the first axis. The first damper includes a housing that defines a chamber for receipt of hydraulic fluid, and a moveable body in the chamber having a neutral state, a first dampened state, and a second dampened state opposite the first dampened state, the moveable body rotating in the chamber from the neutral state to the first and second dampened states.

According to yet another embodiment of the present disclosure, a method is provided for operating a work vehicle, the work vehicle including a chassis and a work tool rotatably coupled to the chassis. The method includes the steps of: providing a housing with a chamber that contains hydraulic fluid; and rotating a moveable body through the hydraulic fluid in the chamber to resist rotation of the work tool relative to the chassis about an axis.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a side perspective view of an exemplary grapple skidder of the present disclosure, the grapple skidder including a chassis and a grapple tool coupled to the chassis via a swivel link;

FIG. 2 is a rear perspective view of the swivel link of FIG. 1;

FIG. 3 is a side perspective view of the swivel link of FIG. 1;

FIG. 4 is another perspective view of the swivel link of FIG. 1, the swivel link including a first damper and a second damper;

FIG. 5 is a partially exploded view of the swivel link of FIG. 4 showing the first damper;

FIG. 6 is another partially exploded view of the swivel link of FIG. 4 showing the first damper;

FIG. 7 is a schematic view of the first damper in a neutral state;

FIG. 8 is a schematic view of the first damper in a first dampened state; and

FIG. 9 is a schematic view of the first damper in a second dampened state opposite the first dampened state.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

FIG. 1 provides a forestry work vehicle in the form of a grapple skidder 10. Skidder 10 includes chassis 12. Skidder 10 also includes at least one traction device 14, illustratively a plurality of wheels, to support chassis 12 on the ground. Although traction devices 14 are shown as wheels in FIG. 1, it is also within the scope of the present disclosure that traction devices 14 may include tracks, for example.

Skidder 10 also includes an engine compartment 16 that houses an engine (not shown). In operation, the engine communicates with traction devices 14 to propel chassis 12 across the ground.

Skidder 10 further includes an operator cab 18 supported by chassis 12 to house and protect the operator of skidder 10. Operator cab 18 may include a seat and various controls or user inputs for driving skidder 10 and operating various work tools attached to skidder 10. The work tools of skidder 10 are described further below.

In the illustrated embodiment of FIG. 1, skidder 10 includes two work tools—a front-mounted blade 20 and a rear-mounted grapple 26 having tongs 28. Blade 20 is moveably coupled to chassis 12 to spread and distribute dirt and other materials. Grapple 26 is moveably coupled to chassis 12 to lift and haul logs. Grapple 26 may be raised and lowered relative to chassis 12 via boom assembly 22, which includes one or more hydraulic cylinders 24. Grapple 26 may also be rotated relative to chassis 12 via a hydraulic motor 32 located in boom assembly 22, although the location of motor 32 may vary. Grapple 26 may also swivel fore-aft and side-to-side relative to chassis 12 via swivel link 30, which is described further below.

Grapple 26 is shown hanging vertically from swivel link 30 along vertical axis V in FIG. 1. Swivel link 30 is pivotally coupled to boom assembly 22 by a first pivot connection 34, and swivel link 30 is pivotally coupled to grapple 26 by a second pivot connection 36. The first pivot connection 34 allows grapple 26 to swing fore-aft about a first pivot axis A. The second pivot connection 36 allows grapple 26 to swing side-to-side about a second pivot axis B, which is orthogonal to the first pivot axis A.

Swivel link 30 is shown in more detail in FIGS. 2-4. The illustrative swivel link 30 includes a generally hollow housing 40, at least one first damper 44 arranged along the first pivot connection 34, and at least one second damper 46 arranged along the second pivot connection 36. As shown in FIG. 2, first damper 44 receives a first pivot pin 52 of boom assembly 22 along the first pivot connection 34. Although boom assembly 22 includes two spaced-apart pivot pins 52, only one of the two pivot pins 52 interacts with the corresponding first damper 44 in FIG. 2. As shown in FIG. 3, second damper 46 receives a second pivot pin 56 of grapple 26 along the second pivot connection 36. Although the illustrative swivel link 30 of FIGS. 2-3 includes a single first damper 44 and a single second damper 46, it is within the scope of the present disclosure to provide more than one first damper 44 to interact with both pivot pins 52 of boom assembly 22 and/or more than one second damper 46 to interact with multiple pivot pins 56 of grapple 26, for example.

First damper 44 of swivel link 30 is shown in more detail in the exploded views of FIGS. 5 and 6. According to an exemplary embodiment of the present disclosure, second damper 46 is structurally identical to first damper 44. Thus, the following description of first damper 44 may also apply to second damper 46.

Housing 40 of swivel link 30 defines a generally cylindrical chamber 60 that is filled with hydraulic fluid. Chamber 60 may have a diameter of about 50 mm, 70 mm, 90 mm, 110 mm, or more, although the size of chamber 60 may vary to accommodate necessary loads on first damper 44. Around the periphery of chamber 60, housing 40 includes an annular groove 62 that is configured to receive an O-ring seal 63.

Housing 40 also includes a plurality of receptacles 64 around chamber 60 and a plurality of receptacles 66 inside chamber 60, which are described further below. Housing 40 may be constructed of ductile iron or another suitable material.

An exemplary hydraulic fluid for use in chamber 60 of housing 40 is a low viscosity, winter-grade engine or hydraulic oil that will deliver consistent performance across a wide range of operating temperatures. Chamber 60 may be filled by introducing the hydraulic fluid into a drain port 100 located near the bottom side of chamber 60 or a check port 102 located near the top side of chamber 60, and allowing the hydraulic fluid to fill to the level of check port 102 located near the top side of chamber 60. When chamber 60 is filled and in use, drain port 100 and check port 102 may be plugged or otherwise closed to prevent the hydraulic fluid from exiting chamber 60. A small amount of air may also be present in chamber 60 along with the hydraulic fluid to accommodate thermal expansion. A vent port 104 equipped with a pressure relief valve (not shown) may be provided in housing 40 to relieve excess pressure from chamber 60. When necessary, used hydraulic fluid may be removed from chamber 60 via drain port 100 and replaced with new hydraulic fluid.

First damper 44 also includes a cover 70 that is removably coupled to housing 40 to conceal and close chamber 60. A plurality of fasteners 72 (e.g., bolts) extend through cover 70 and into receptacles 64 in housing 40 to removably secure cover 70 onto housing 40. When assembled, seal 63 in groove 62 interacts with housing 40 and cover 70 to provide a seal around chamber 60. Cover 70 may be constructed of ductile iron, gray iron, or another suitable material.

First damper 44 further includes a stationary divider 80 inside chamber 60 of housing 40. The illustrative divider 80 extends vertically across the diameter of chamber 60 to divide chamber 60 into a first compartment A (illustratively located on the right side of divider 80 in FIGS. 7-9) and a second compartment B (illustratively located on the left side of divider 80 in FIGS. 7-9). Divider 80 may be constructed of a stack of layered panels. One or more panels in the stack may be custom molded or laser cut to a specified length and width to seal against housing 40 and cover 70. A rectangular seal (not shown) may also be provided around the perimeter of divider 80 to seal divider 80 against housing 40 and cover 70. As shown in FIG. 6, divider 80 includes a central opening 82, which may be machined into the layered panels. As shown in FIG. 5, a plurality of pins 84 (e.g., dowel rods) extend from divider 80 and into receptacles 66 in chamber 60 of housing 40 to stabilize divider 80 in housing 40 and to reduce stresses on divider 80 under pressure.

Referring next to FIGS. 7-9, divider 80 includes a plurality of one-way, first direction flow paths 82, 82′ from the first compartment A to the second compartment B, and a plurality of one-way, second direction flow paths 84, 84′ opposite the first direction flow paths 82, 82′ from the second compartment B to the first compartment A. In operation, when the pressure in the first compartment A exceeds a predetermined pressure, hydraulic fluid may escape from the high-pressure first compartment A via corresponding first direction flow paths 82, 82′. When the pressure in the second compartment B exceeds a predetermined pressure, hydraulic fluid may escape from the high-pressure first compartment B via corresponding second direction flow paths 84, 84′.

The flow of hydraulic fluid between the first and second compartments A, B through flow paths 82, 82′, 84, 84′ may be controlled using orifices of predetermined sizes, check valves having predetermined cracking pressures, or pressure relief valves having predetermined relief pressures, for example. A suitable valve may include the E14814 Relief Valve available from Deere & Company of Moline, Ill. It is also within the scope of the present disclosure that the predetermined pressure may be adjustable, such as by altering the cracking pressure of a corresponding check valve or the relief pressure of a corresponding pressure relief valve. In this manner, the sensitivity of first damper 44 may be adjusted during use. The relief pressure of vent port 104 may be set higher than the predetermined escape pressure through flow paths 82, 82′, 84, 84′, to ensure that the hydraulic fluid travels through flow paths 82, 82′, 84, 84′ in normal use before escaping from chamber 60 via vent port 104.

Returning to FIGS. 5 and 6, first damper 44 further includes a rotatable body 90 inside chamber 60 of housing 40. Body 90 includes a central shaft 92 and one or more fins or vanes, illustratively a first vane 94A and a second vane 94B, that extend radially outward from the central shaft 92. Vanes 94A, 94B are illustratively arranged 180 degrees apart to extend in opposite directions from central shaft 92 of body 90. Central shaft 92 of body 90 is coupled to pivot pin 52 of boom assembly 22 (FIG. 2) for rotation therewith relative to housing 40. Central shaft 92 of body 90 may be coupled to pivot pin 52 via a spline 93, a keyway, or another suitable feature that transmits rotation of pivot pin 52 to central shaft 92 and vanes 94A, 94B. Central shaft 92 of body 90 is sized and shaped to fit within central opening 82 of divider 80 such that, as body 90 rotates relative to housing 40, body 90 also rotates relative to the stationary divider 80 in housing 40. A bushing 95 may be provided to support rotation of central shaft 92 in housing 40. Like divider 80, body 90 may be constructed of a stack of layered panels, with one or more panels in the stack being custom molded or laser cut to a specified length and width.

On the side of housing 40 opposite from first damper 44, a pin 96 is provided to support rotation of swivel link 30 relative to boom assembly 22 (FIG. 1) along the first pivot connection 34. Pin 96 may be retained in housing 40 using a fastener assembly 97, which may include a washer, bolt, and spacer, for example. Another bushing 98 may also be provided to support pin 96 in housing 40.

Referring again to FIGS. 7-9, first vane 94A of body 90 is shown inside the first compartment A of chamber 60 (illustratively located on the right side of divider 80 in FIGS. 7-9), and second vane 94B of body 90 is shown inside the second compartment B of chamber 60 (illustratively located on the right side of divider 80 in FIGS. 7-9). Vanes 94A, 94B of body 90 extend across the diameter of chamber 60 to further divide the first compartment A of chamber 60 into sub-compartments A1, A2 and to further divide the second compartment B of chamber 60 into sub-compartments B1, B2. Body 90 is shown in a neutral position relative to divider 80 in FIG. 7. Body 90 is shown rotating rearward relative to divider 80 in FIG. 8 to a first dampened state. Body 90 is shown rotating forward relative to divider 80 in FIG. 9 to a second dampened state.

In this embodiment, body 90 may rotate up to about 90 degrees rearward relative to divider 80 from the neutral position and up to about 90 degrees forward relative to divider 80 from the neutral position for a total range of motion approaching about 180 degrees relative to divider 80, such as about 140 degrees, 145 degrees, 150 degrees, or more.

The operation of grapple 26 (FIG. 1) will now be described with continued reference to FIGS. 7-9. At rest, with grapple 26 hanging vertically from boom assembly 22 along vertical axis V (FIG. 1), pivot pin 52 and body 90 may be positioned in the neutral position of FIG. 7. As grapple 26 swings fore-aft relative to boom assembly 22 about pivot axis A (FIG. 1), swivel link 30 will rotate relative to pivot pin 52 of boom assembly 22, causing body 90 to rotate in first damper 44, as shown in FIGS. 8 and 9. As the moveable body 90 moves relative to the stationary divider 80, the pressure in certain sub-compartments A1, A2, B1, B2 of chamber 60 will increase, thereby resisting and dampening the movement of grapple 26. During movement of grapple 26, first damper 44 may encounter torque values between about 1,000 and 2,000 ft*lb_{f}, such as about 1,200 to 1,500 ft*lb_{f}.

In FIG. 8, as the volume of sub-compartments A2, B2 decreases, the pressure therein increases, thereby resisting and dampening the movement of grapple 26.

Some of the hydraulic fluid in the high-pressure sub-compartment A2 (represented by a + symbol) may transfer into the adjacent low-pressure sub-compartment B1 (represented by a − symbol) via the corresponding flow path 82′. Also, some of the hydraulic fluid in the high-pressure sub-compartment B2 (represented by a + symbol) may transfer into the adjacent low-pressure sub-compartment A1 (represented by a − symbol) via the corresponding flow path 84. The pressure at which the hydraulic fluid is able to escape from the high-pressure sub-compartments A2, B2, and transfer into the low-pressure sub-compartments A1, B1, via flow paths 82′, 84, in this embodiment may be selected to restrict movement of grapple 26 while still allowing grapple 26 to move.

In FIG. 9, the sub-compartments A1, A2, B1, B2 alternate or reverse states relative to FIG. 8. As the volume of sub-compartments A1, B1 decreases, the pressure therein increases, thereby resisting and dampening the movement of grapple 26. Some of the hydraulic fluid in the high-pressure sub-compartment A1 (represented by a + symbol) may transfer into the adjacent low-pressure sub-compartment B2 (represented by a − symbol) via the corresponding flow path 82. Also, some of the hydraulic fluid in the high-pressure sub-compartment B1 (represented by a + symbol) may transfer into the adjacent low-pressure sub-compartment A2 (represented by a − symbol) via the corresponding flow path 84′. The pressure at which the hydraulic fluid is able to escape from the high-pressure sub-compartments A1, B1, and transfer into the low-pressure sub-compartments A2, B2, via flow paths 82, 84′, in this embodiment may be selected to restrict movement of grapple 26 while still allowing grapple 26 to move.

After swinging fore-aft, as represented by FIGS. 8 and 9, grapple 26 may be encouraged to return smoothly to the neutral, vertical position of FIG. 7. This vertical position is also shown in FIG. 1. In this vertical position, the operator may easily align grapple 26 with a bundle of logs for the next pick-up.

Advantageously, first and second dampers 44, 46 of the present disclosure may resist and dampen the movement of grapple 26 without experiencing excessive pressures. As the distance available for displacement of body 90 increases, the pressure in first and second dampers 44, 46 decreases. Thus, the level of sealing and precision required to manufacture first and second dampers 44, 46 may decrease. Also, the strength of materials used to manufacture and assemble first and second dampers 44, 46 may decrease.

First and second dampers 44, 46 of the present disclosure may avoid break-in periods and high operating temperatures. Also, first and second dampers 44, 46 may require limited maintenance along with other hydraulic components of skidder 10, such as after each 2,000 service hours. First and second dampers 44, 46 may also experience a long useful life.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A work vehicle including:
a chassis;
at least one traction device supporting the chassis on the ground;
a work tool configured to rotate relative to the chassis about a first axis;
a first damper configured to resist movement of the work tool about the first axis, the first damper including:
a housing that defines a chamber for receipt of hydraulic fluid; and
a moveable body that rotates in the chamber, the hydraulic fluid resisting rotation of the moveable body in the chamber to resist movement of the work tool about the first axis.

2. The work vehicle of claim 1, wherein the work tool includes a grapple with tongs.

3. The work vehicle of claim 1, wherein the moveable body rotates about the first axis.

4. The work vehicle of claim 1, wherein the moveable body divides the chamber into a first compartment on a first side of the moveable body and a second compartment on a second side of the moveable body.

5. The work vehicle of claim 4, wherein a pressure in the first compartment increases as a pressure in the second compartment decreases.

6. The work vehicle of claim 4, wherein the first damper further includes a divider that divides the first compartment into first and second sub-compartments and that divides the second compartment into third and fourth sub-compartments.

7. The work vehicle of claim 6, wherein the divider includes at least one flow path between the first and second sub-compartments and at least another flow path between the third and fourth sub-compartments.

8. The work vehicle of claim 1, further including a second damper configured to resist movement of the work tool about a second axis perpendicular to the first axis.

9. The work vehicle of claim 1, wherein the moveable body is configured to rotate about 140 degrees or more in the chamber.

10. A work vehicle including:
a chassis;
at least one traction device supporting the chassis on the ground;
a work tool configured to rotate relative to the chassis about a first axis;
a first damper configured to resist movement of the work tool about the first axis, the first damper including:
a housing that defines a chamber for receipt of hydraulic fluid; and
a moveable body in the chamber having a neutral state, a first dampened state, and a second dampened state opposite the first dampened state, the moveable body rotating in the chamber from the neutral state to the first and second dampened states.

11. The work vehicle of claim 10, wherein the moveable body is configured to rotate about 70 degrees or more from the neutral state to the first dampened state and about 70 degrees or more from the neutral state to the second dampened state.

12. The work vehicle of claim 10, wherein the moveable body pressurizes a first zone of hydraulic fluid in the first dampened state and a second zone of hydraulic fluid in the second dampened state.

13. The work vehicle of claim 12, wherein the moveable body pressurizes a third zone of hydraulic fluid in addition to the first zone in the first dampened state and a fourth zone of hydraulic fluid in addition to the second zone in the second dampened state, wherein the first and third zones are located diagonally across the chamber from one another, and the second and fourth zones are located diagonally across the chamber from one another.

14. The work vehicle of claim 12, wherein the first damper includes at least one first escape path from the first zone in the first dampened state and at least one second escape path from the second zone in the second dampened state.

15. The work vehicle of claim 10, wherein the work tool hangs vertically from the chassis when the moveable body of the first damper is in the neutral state and tilts relative to the chassis when the moveable body of the first damper is in the first or second dampened state.

16. The work vehicle of claim 10, further including a second damper configured to resist movement of the work tool about a second axis perpendicular to the first axis.

17. A method of operating a work vehicle, the work vehicle including a chassis and a work tool rotatably coupled to the chassis, the method including the steps of:
providing a housing with a chamber that contains hydraulic fluid; and
rotating a moveable body through the hydraulic fluid in the chamber to resist rotation of the work tool relative to the chassis about an axis.

18. The method of claim 17, wherein the moveable body and the work tool rotate about the same axis during the rotating step.

19. The method of claim 17, wherein the rotating step forces the hydraulic fluid in the chamber to escape into another chamber in the housing.

20. The method of claim 17, further comprising the steps of:
providing a second chamber in the housing that contains hydraulic fluid; and
rotating a second moveable body through the hydraulic fluid in the second chamber to resist rotation of the work tool relative to the chassis about a second axis perpendicular to the axis.
